(19) United States
(12) Patent Application Publication
(10) Pub. No.: US 2013/0120230 A1
(43) Pub. Date: May 16, 2013

(54) Flat Display Panel And A Method Of Repairing The Same

(71) Applicants: Ya-hui Chen, Shenzhen (CN); Tsunglung Chang, Shenzhen (CN)

(72) Inventors: Ya-hui Chen, Shenzhen (CN); Tsunglung Chang, Shenzhen (CN)

(73) Assignee: SHENZHEN CHINA STAR OPTOELECTRONICS TECHNOLOGY CO., LTD., Shenzhen (CN)

(21) Appl. No.: 13/379,020

(22) PCT Filed: Nov. 16, 2011
(86) PCT No.: PCT/CN11/82252

§ 371 Date: Dec. 17, 2011

(30) Foreign Application Priority Data
Nov. 14, 2011 (CN) 201110359711.4

(51) Int. Cl. G09G 3/36; H01J 9/50

(52) U.S. Cl. 345/92; 445/2

(57) ABSTRACT

A flat display panel and a method of repairing the same are proposed. The flat display panel includes a plurality of repairing lines parallel to data lines. The plurality of repairing lines are disposed at one side of a plurality of pixel electrodes one on one. When one of the plurality of data lines is broken, repairing lines form an electrical bypass route for circumventing a gap in the broken data line. Thus, a signal can be normally transmitted to the pixel electrode through the electrical bypass route.

### BACKGROUND OF THE INVENTION

1. Field of the Invention

The present invention relates to a flat display panel and a method of repairing the same, and more particularly, to a flat display panel comprising a repairing line structure and a method of repairing broken lines.

2. Description of the Prior Art

Nowadays, light and thin flat display panels are widely used in current consumer electronic products. Liquid crystal displays (LCDs) which are colorful monitors with high resolution are widely used in various electronic products such as monitors for mobile phones, personal digital assistants (PDAs), digital cameras, laptop computers, and notebook computers.

A thin-film transistor liquid crystal display (TFT-LCD) panel has gradually become a mainstream product in the consumer electronics market because it has many advantages, such as high quality, efficient utilization of space, low consumption power, and no radiation. Referring to FIG. 1, a partial schematic diagram of a conventional LCD panel is shown. The conventional LCD panel comprises a plurality of pixel electrodes 100, a plurality of data lines 102 arranged in columns, and a plurality of scan lines 101 arranged in rows. A pixel electrode 100 is connected to a scan line 101 and to a data line 102 through a TFT 103. The TFT 103 is brought into conduction or cutoff in response to a scan signal transmitted through the scan line 101. When the scan signal transmitted through the scan line 101 is at a high level, the TFT 103 conducts so that data voltage applied to the data line 102 can be output to the pixel electrode 100. Liquid crystal (LC) molecules between the pixel electrode 100 and a common line 105 rotate to show different grayscales depending upon a voltage difference between the data voltage received by the pixel electrode 100 and common voltage provided by the common line 105.

However, there is sometimes a gap G in the data line 102 in the manufacturing processes of LCD panels. Generally speaking, chemical vapor deposition repair (CVD repair) is used to repair the data line 102 if the data line 102 is examined to have been broken before a process of cell. However, if the data line 102 is still found to be broken after the process of cell, the LCD panel is scrapped at present. This causes unnecessary waste, affects the product yield, and increases the manufacturing cost of the LCD panel.

### SUMMARY OF THE INVENTION

Therefore, an object of the present invention is to provide a flat display panel comprising a structure having repairing lines and a method of repairing broken lines thereof. After the process of cell, laser is used to connect specific repairing lines so that signals which are unable to be transmitted through broken data lines can be transmitted through the repairing lines. The flat display panel comprising a structure having repairing lines and the method of repairing broken lines thereof are able to lower the number of scrapped products, thereby solving the problem occurring in the prior art.

According to the present invention, a flat display panel, comprising: a plurality of matrix-arranged pixel electrodes; a plurality of scan lines in rows, parallel to one another and extended along a first direction, for transmitting scan signals; a plurality of data lines in columns, parallel to one another and extended along a second direction which is perpendicular to the first direction, for transmitting data signals; a plurality of thin-film transistors (TFTs), coupled to the plurality of pixel electrodes, the plurality of scan lines in rows, and the plurality of data lines in columns one on one, each of the plurality of TFTs conducting a coupled data line when each of the plurality of TFTs receives a scan signal transmitted through a coupled scan line, the data signal transmitted through the coupled data line to a corresponding pixel electrode; and a plurality of repairing lines, parallel to and overlapped with the plurality of data lines in columns, the plurality of repairing lines disposed at one side of the plurality of pixel electrodes one on one and disconnected to one another, the plurality of repairing lines and the plurality of scan lines in rows made of the same metallic layer.

In one aspect of the present invention, each of the plurality of repairing lines is in a shape of a letter “I”.

In one aspect of the present invention, the flat display panel further comprises a plurality of connecting units, each of the plurality of connecting units having two ends, and the two ends overlapped with one end of two repairing lines in the same column, respectively, wherein when one of the data line is broken to form a gap, two of the plurality of repairing lines overlapped with the broken data line which is unable to transmit the data signal to the pixel electrode are chosen, the two repairing lines are placed at two sides of the gap of the broken data line and are overlapped with one of the plurality of connecting units, and the two repairing lines are electrically connected to the broken data line and the connecting unit.

In one aspect of the present invention, the flat display panel further comprises an insulating layer placed between the plurality of repairing lines and the data line and a passivation layer placed between the plurality of connecting units and the data line.

In one aspect of the present invention, when one of the plurality of data lines is broken to form a gap which is unable to transmit data signal, two ends of the gap of the broken data line are electrically connected to one of the plurality of repairing lines which is overlapped with the broken data line.

According to the present invention, a method of repairing a flat display panel, comprising: providing a glass substrate; forming a first metallic layer on the glass substrate; etching the first metallic layer, for forming gates of a plurality of TFTs, a plurality of repairing lines, and a plurality of scan lines; forming an insulating layer on the gates of the TFTs, on the repairing lines, and on the scan lines; forming a semiconductor layer on the insulating layer;
etching the semiconductor layer, for forming channels of the TFTs; and forming and etching a second metallic layer, for forming sources and drains of the TFTs and a plurality of data lines.

In one aspect of the present invention, the method comprises steps of: when one of the plurality of data lines is broken to form a gap which is over one of the repairing lines, selecting the repairing line overlapping the gap of the broken data line, and electrically connecting the broken data line with the selected repairing line; forming a passivation layer on the data lines, the sources and the drains of the TFTs; and forming a transparent conducting layer on the passivation layer.

In one aspect of the present invention, when one of the plurality of data lines is broken to form a gap which is not over any repairing lines, selecting two of the repairing lines which overlap two ends of the gap of the broken data line respectively, and electrically connecting the broken data line with the two selected repairing lines; forming a passivation layer on the data lines, the sources and the drains of the TFTs; forming a transparent conducting layer on the passivation layer; etching the transparent conducting layer to form a connecting unit over the two selected repairing lines; and electrically connecting the two repairing lines with the connecting unit.

In one aspect of the present invention, the step of electrically connecting the broken data line with the two selected repairing lines is realized by irradiating overlapping areas of the two repairing lines and the broken data line with laser to weld the two repairing lines and the broken data line, and the step of electrically connecting the two repairing lines with the connecting unit is realized by irradiating the overlapping area of the two repairing lines and the connecting unit with laser to weld the two repairing lines and the connecting unit.

In one aspect of the present invention, after the passivation layer is formed, the method further comprises: etching the passivation layer, for forming a via on the drain; and etching the transparent conducting layer to form a pixel electrode.

Contrast to the prior art, the flat display panel comprising a structure having repairing lines and the method of repairing broken lines thereof are proposed. Some specific repairing lines and connecting units are connected via laser so that data signals can be transmitted through an electrical bypass route formed by the repairing lines and connecting units instead of being transmitted through broken lines. So the flat display panel comprising a structure having repairing lines and the method of repairing broken lines thereof can reduce scrapped products.

These and other features, aspects and advantages of the present disclosure will become understood with reference to the following description, appended claims and accompanying figures.

### BRIEF DESCRIPTION OF THE DRAWINGS

FIG. 1 shows a partial schematic diagram of a conventional LCD panel.

FIG. 2 shows a partial schematic diagram of a flat display panel comprising a structure having repairing lines before a broken data line is repaired according to a first embodiment of the present invention.

FIGS. 3-7 illustrate schematic diagrams of repairing the flat display panel in the present invention.

FIG. 8 shows a partial schematic diagram of a flat display panel comprising a structure having repairing lines before a broken data line is repaired according to a second embodiment of the present invention.

FIGS. 9-13 illustrate schematic diagrams of repairing the flat display panel according to the present invention.

FIG. 14 shows a partial schematic diagram of a flat display panel comprising a structure having repairing lines before a broken data line is repaired according to a third embodiment of the present invention.

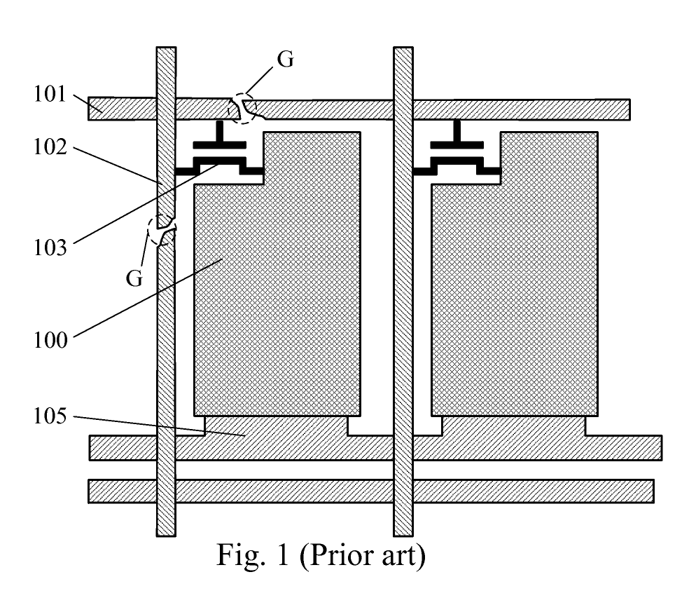

### DETAILED DESCRIPTION OF THE PREFERRED EMBODIMENTS

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

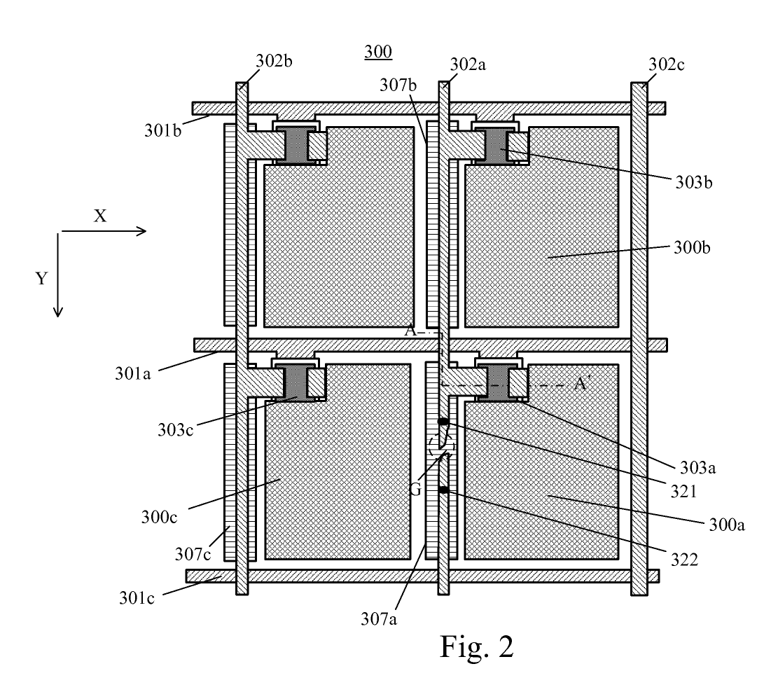

Referring to FIG. 2, FIG. 2 shows a partial schematic diagram of a flat display panel 300 comprising a structure having repairing lines before a broken data line is repaired according to a first embodiment of the present invention. The flat display panel 300 comprises a plurality of pixel electrodes, and hundreds of scan lines, data lines, and repairing lines. To simplify illustrations and to facilitate descriptions, the flat display panel 300 is partially illustrated in the embodiment. The flat display panel 300 comprises a plurality of matrix-arranged pixel electrodes 300a, 300b and 300c, a plurality of scan lines 301a, 301b, and 301c parallel to one another and extended along a first direction X, a plurality of data lines 302a, 302b, and 302c parallel to one another and extended along a second direction Y, a plurality of TFTs 303a, 303b, and 303c, and a plurality of repairing lines 307a, 307b, and 307c parallel to the data line 302a. The second direction Y is perpendicular to the first direction X. The TFT 303a has a gate coupled to the scan line 301a, a source coupled to the data line 302a, and a drain coupled to the pixel electrode 300a. The structure and connecting relation of the TFTs 303b and 303c is the same as that of the TFT 303a, so no further details are released hereafter. When the TFT 303a receives a scan signal transmitted through the coupled scan line 301a, a data signal transmitted through the coupled data line 302a is transmitted to the corresponding pixel electrode 300a. LC molecules between the pixel electrode 300a and the common line 305 rotate to show different grayscales depending upon data voltage applied to the pixel electrode 300a.

In the process of cell, a photo etching process (PEP) with a mask is conducted on a first metallic layer (not shown) to form a plurality of scan lines 301a, 301b, and 301c in rows, and a plurality of repairing lines 307a, 307b, and 307c simultaneously. The plurality of repairing lines 307a, 307b, and 307c are disposed on one side of the plurality of pixel electrodes 300a, 300b, and 300c one on one. Next, a PEP with another mask is conducted on a second metallic layer (not shown) to form a plurality of data lines 302a, 302b, and 302c in columns. At least one insulating layer 351 (not shown) is placed between the first metallic layer comprising the plurality of scan lines 301a, 301b, and 301c, and the plurality of repairing lines 307a, 307b, and 307c and the second metallic layer comprising the plurality of data lines 302a, 302b, and 302c for preventing the plurality of scan lines, repairing lines, and data lines from being electrically connected directly. Preferably, a plurality of repairing lines corresponding to a data line in the same column at one side of a plurality of pixel electrodes 300a and 300b is overlapped with the data line. For example, the data line 302a is overlapped with the repairing lines 307a and 307b.

In the process of cell, the plurality of data lines 302a and 302b are examined to see if the data signal can be normally transmitted through each of the plurality of data lines 302a and 302b. Once the data line 302a has a gap G, as shown in FIG. 2, the data signal cannot pass through. At this time, select the repairing line 307a and melt two ends 321 and 322 of the gap G with laser. An opening is formed on the insulating layer 351 under the two ends 321 and 322 with laser. The melted data line 302a made of metallic materials contacts the repairing line 307a under the data line 302a via the opening. So, the data line 302a is electrically connected to the repairing line 307a.

As described above, the gap G is circumvented and the data line 302a and the repairing line 307a form an electrical bypass route. Thus, the data signal can still be transmitted through the electrical bypass route instead of passing through the gap G in the data line 302a.

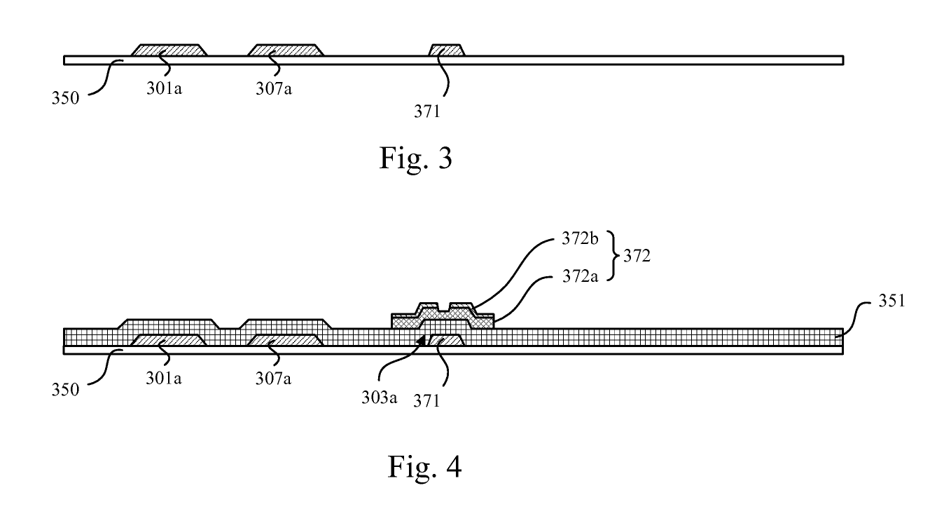

The manufacturing processes of the flat display panel 300 of the present invention will be disclosed as follows. FIGS. 3-7 illustrate schematic diagrams of repairing the flat display panel 300 in the present invention.

Referring to FIG. 3, a glass substrate 350 serves as a lower substrate. A metallic thin-film deposition is conducted on the glass substrate 350 to form a first metallic layer (not shown) on the surface of the glass substrate 350. Also, a first PEP is conducted using a first mask to form the gate 371 of the TFT 303a, the repairing line 307a, and the scan line 301a.

Referring to FIG. 4, an insulating layer 351 made of silicon nitride (SiNx) is deposited and covers the gate 371, the repairing line 307a, and the scan line 301a. An amorphous Si (a-Si) layer and an N+ a-Si layer at high electron doping concentrations are deposited on the insulating layer 351 successively. A semiconductor layer 372 is formed after a second PEP is conducted using a second mask. The semiconductor layer 372 comprises an a-Si layer 372a and an ohmic contact layer 372b. The a-Si layer 372a serves as a channel of the TFT 303a; the ohmic contact layer 372b is used for reducing resistance.

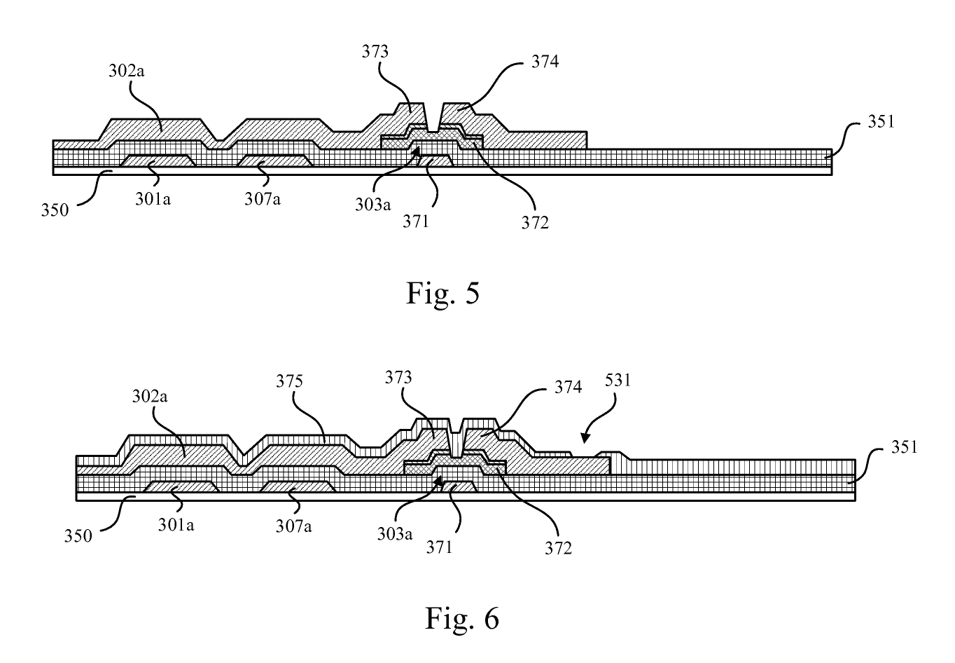

Referring to FIG. 5, a second metallic layer (not shown) is formed on the insulating layer 351 and covers the insulating layer 351 completely. The source 373 of the TFT 303a, the drain 374 of the TFT 303a, and the data line 302a are defined after a third PEP is conducted using a third mask. The data line 302a is directly connected to the source 373.

Referring to FIG. 6, a passivation layer 375 made of SiNx is deposited, covering the source 373, the drain 374, and the data line 302a. Next, a fourth PEP is conducted using a fourth mask to remove part of the passivation layer 375 on the drain 374 until the surface of the drain 374 is exposed. A via 531 is formed on the drain 374.

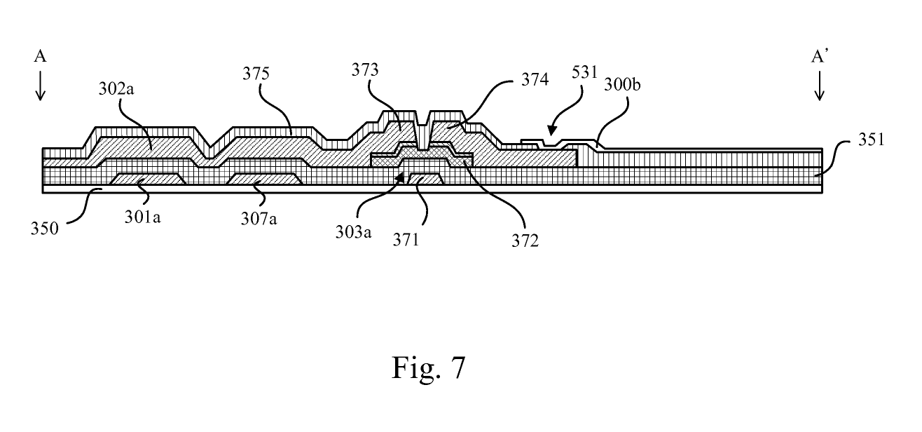

FIG. 7 is a cross section view of the flat display panel 300 taken along line A-A′ of FIG. 2. A transparent conducting layer made of indium tin oxide (ITO) is formed on the passivation layer 375. Next, the pixel electrode 300b is formed after the transparent conducting layer is etched using a fifth mask. The pixel electrode 300b is electrically connected to the drain 374 of the TFT 303a via the via 531 formed beforehand.

The plurality of data lines are detected whether to be normal or not after the third PEP is conducted, as shown in FIG. 5. If the data line 302a is broken, the two ends 321 and 322 (shown in FIG. 2) of the gap G in the data line 302a are chosen as irradiation points for laser. An opening is formed on the insulating layer 351 under the two ends 321 and 322 with laser. After the data line 302a made of metallic materials is melted, the data line 302a contacts the repairing line 307a via the opening. Thus, the data line 302a is electrically connected to the repairing line 307a. After the third PEP finishes, fourth and fifth PEPs are conducted, as shown in FIG. 6 and in FIG. 7.

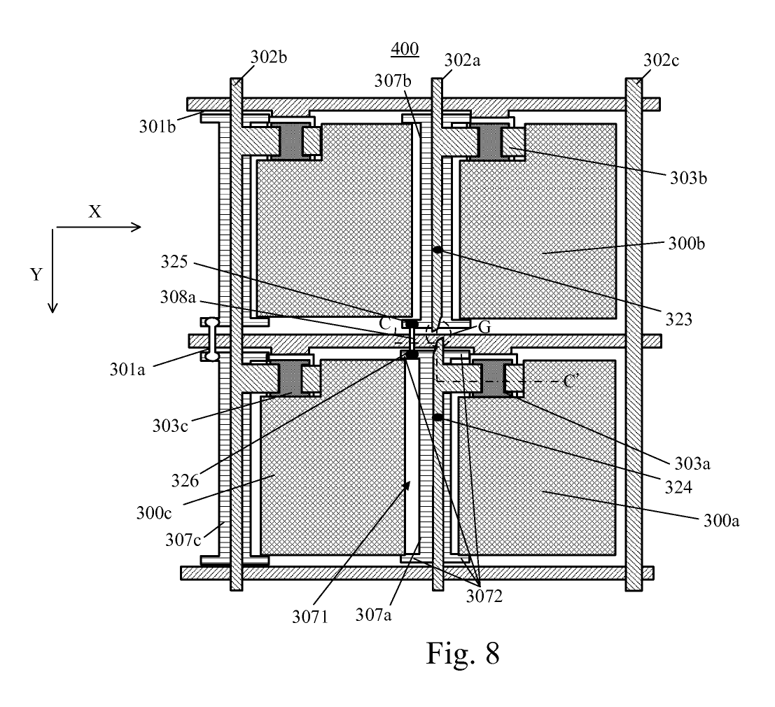

Referring to FIG. 8, FIG. 8 shows a partial schematic diagram of a flat display panel 400 comprising a structure having repairing lines before a broken data line is repaired according to a second embodiment of the present invention. To simplify the description, elements in FIG. 8 having the same structure as those in FIG. 2 will be labeled by the same numerals. Differing from the flat display panel 300 as shown in FIG. 2, a connecting unit 308a is placed between the two repairing lines 307a and 307b in the same row at one side of the flat display panel 400. Two ends of the connecting unit 308a are overlapped with one end of the repairing line 307a and one end of the repairing line 307b, respectively. In the process of cell, a first metallic layer (not shown) is etched using the PEP with a mask to form a plurality of scan lines 301a, 301b, and 301c in rows, and a plurality of repairing lines 307a, 307b, and 307c. The plurality of repairing lines 307a, 307b, and 307c are disposed at one side of the plurality of pixel electrodes one on one. Afterwards, a second metallic layer (not shown) is etched using the PEP with another mask to form a plurality of data lines 302a, 302b, and 302c in columns. At least one insulating layer 351 (not shown) is placed between the first metallic layer and the second metallic layer for preventing the plurality of scan lines, repairing lines, and data lines from being electrically connected directly. The transparent conducting layer (such as an ITO layer) is etched using the PEP with another mask to form the connecting unit 308a. At least one passivation layer 375 (not shown) is placed between the connecting unit 308a and the data line 302a for preventing the plurality of scan lines, repairing lines, and data lines from being electrically connected directly. Preferably, the plurality of repairing lines in the same column at one side of the plurality of pixel electrodes 300a and 300b are overlapped with the data line 302a in a column. For instance, the data line 302a is overlapped with the repairing lines 307a and 307b. It is notified that the width of the plurality of repairing lines 307a, 307b, and 307c has to be larger than that of the plurality of data lines 302a, 302b, and 302c. The connecting unit 308a is not overlapped with the corresponding data line 302a. Preferably, the plurality of repairing lines 307a, 307b, and 307c are substantially shaped as a letter “I”. The protrusive parts 3072 of the repairing lines 307a and 307b in the “I”-shaped is overlapped with the connecting unit 308a, and the pixel electrode 300a can be extended to the intrusive part 3071 of the repairing line 307a. Therefore, the aperture rate of the pixel electrode 300a is not affected.

In the process of cell, the plurality of data lines 302a and 302b are detected to see if a data signal can be normally transmitted through each of the plurality of data lines 302a and 302b. If the gap G exists in the data line 302a, as shown in FIG. 8, the data signal cannot pass through. At this time, select the repairing lines 307a and 307b near the gap G and melt two ends 323 and 324 of the gap G with laser. An opening is formed on the insulating layer 351 under the two ends 323 and 324 with laser. The melted data line 302a made of metallic materials contacts the repairing lines 307a and 307b via the opening. Moreover, two ends 325 and 326 near the gap G in the connecting unit 308a are melted with laser. A via is formed on the insulating layer 351 and on the passivation layer 375 under the two ends 325 and 326 with laser. The melted connecting unit 308a made of transparent conducting materials can contact the repairing lines 307a and 307b via the opening. Thus, the data line 302a, the connecting unit 308a, and the repairing lines 307a and 307b are electrically connected.

After the laser irradiation process, the connecting unit 308a and the repairing lines 307a and 307b form an electrical bypass route for circumventing the gap G in the data line 302a. Thus, the data signal can be normally transmitted through the electrical bypass route without passing through the gap G in the data line 302a.

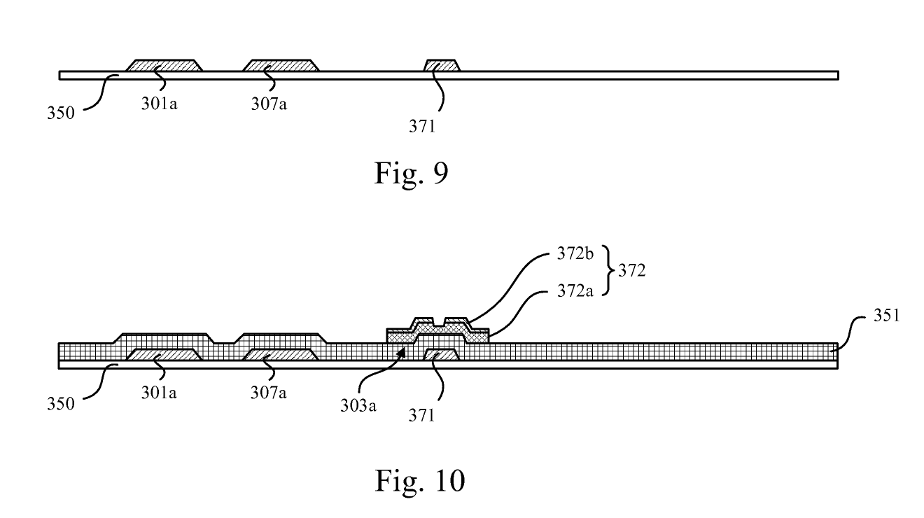

The manufacturing processes of a flat display panel 400 of the present invention will be disclosed as follows. FIGS. 9-13 illustrate schematic diagrams of repairing the flat display panel 400 according to the present invention.

Referring to FIG. 9, a glass substrate 350 serves as a lower substrate. A metallic thin-film deposition is conducted on the glass substrate 350 to form a first metallic layer (not shown) on the surface of the glass substrate 350. Also, a first PEP is conducted using a first mask to form a gate 371 of a TFT 303a, a repairing line 307a, and a scan line 301a.

Referring to FIG. 10, an insulating layer 351 made of SiNx is deposited and covers the gate 371, the repairing line 307a, and the scan line 301a. An a-Si layer and an N+ a-Si layer at high electron doping concentrations are deposited on the insulating layer 351 successively. A semiconductor layer 372 is formed after a second PEP is conducted using a second mask. The semiconductor layer 372 comprises an a-Si layer 372a and an ohmic contact layer 372b. The a-Si layer 372a serves as a channel of the TFT 303a; the ohmic contact layer 372b is used for reducing resistance.

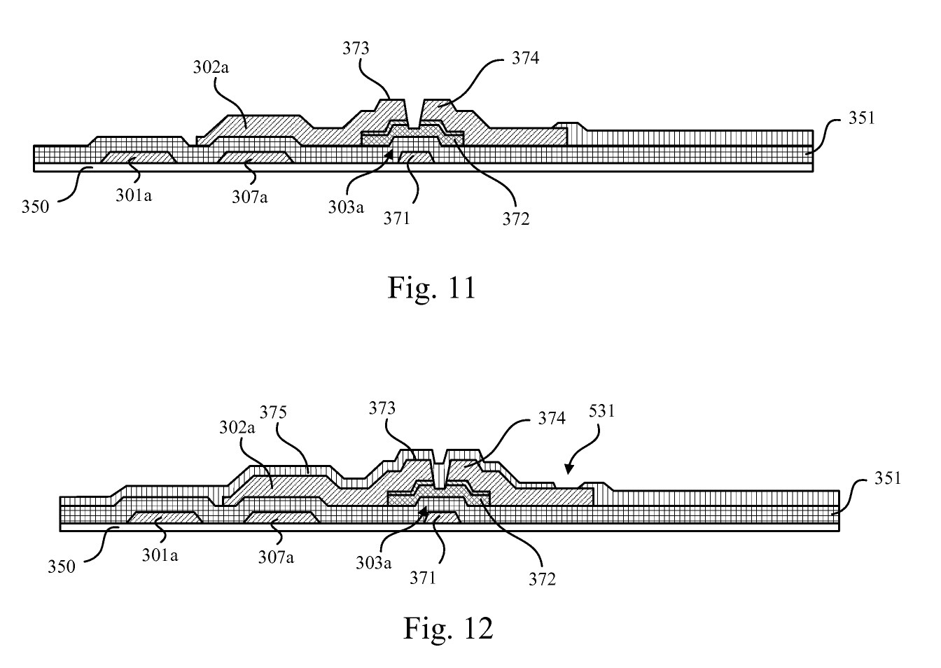

Referring to FIG. 11, a second metallic layer (not shown) is formed on the insulating layer 351 and covers the insulating layer 351 completely. A source 373 of the TFT 303a, a drain 374 of the TFT 303a, and the data line 302a are defined after a third PEP is conducted using a third mask. The data line 302a is directly connected to the source 373.

Referring to FIG. 12, a passivation layer 375 made of SiNx is deposited, covering the source 373, the drain 374, and the insulating layer 351. Next, a fourth PEP is conducted using a fourth mask to remove part of the passivation layer 375 on the drain 374 until the surface of the drain 374 is exposed. A via 531 is formed on the drain 374.

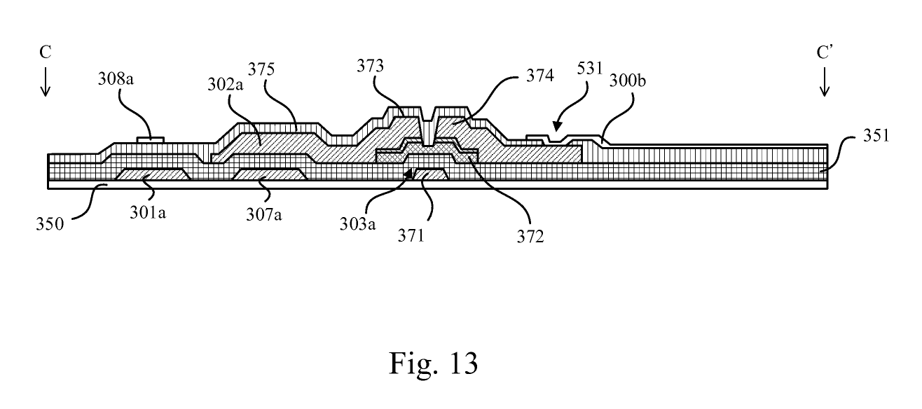

Referring to FIG. 13, a cross section view of the flat display panel 400 taken along line C-C′ of FIG. 8 is shown. A transparent conducting layer made of ITO is formed on the passivation layer 375. Next, a pixel electrode 300b and a connecting unit 308a are formed after the transparent conducting layer is etched using a fifth mask. The pixel electrode 300b is electrically connected to the drain 374 of the TFT 303a via the via 531 formed beforehand.

The plurality of data lines are detected whether to be broken or not after the third PEP is conducted, as shown in FIG. 11. If the data line 302a is broken, two ends 323 and 324 (shown in FIG. 8) of a gap G in the data line 302a are chosen as irradiation points for laser. An opening is formed on the insulating layer 351 under the two ends 323 and 324 with laser. After the data line 302a made of metallic materials is melted, the data line 302a contacts repairing lines 307a and 307b via the opening. Thus, the data line 302a is electrically connected to the repairing lines 307a and 307b. After the third PEP finishes, fourth and fifth PEPs are conducted, as shown in FIG. 12 and in FIG. 13.

Because the data line 302a is broken after the fifth PEP, two ends 325 and 326 (shown in FIG. 8) of the connecting unit 308a are chosen as irradiation points for laser. An opening is formed on the insulating layer 351 and the passivation layer 375 under the two ends 325 and 326 with laser. After the connecting unit 308a made of transparent conducting materials is melted, the connecting unit 308a contacts the repairing lines 307a and 307b via the opening. Thus, the connecting unit 308a is electrically connected to the repairing lines 307a and 307b.

After the laser irradiation process, the data line 302a, the connecting unit 308a, and the repairing lines 307a and 307b form an electrical bypass route for circumventing the gap G. Thus, a data signal can be transmitted through the electrical bypass route normally without passing through the gap G in the data line 302a.

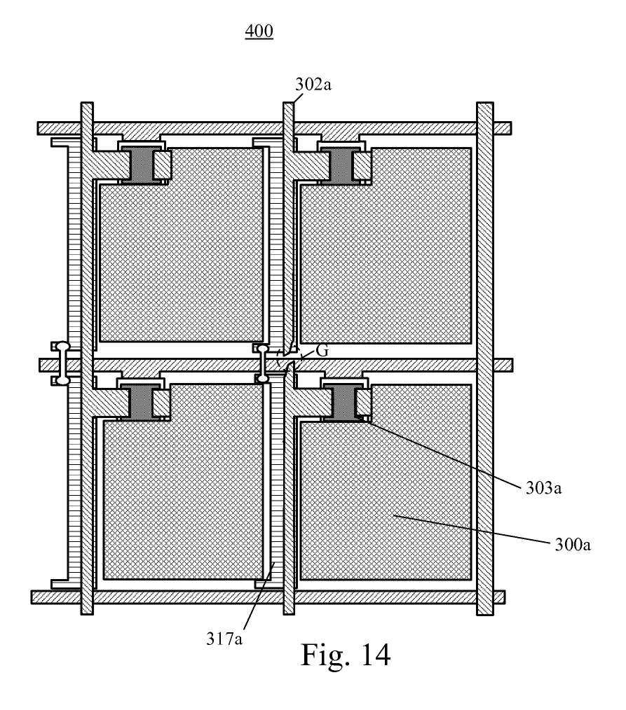

Please refer FIG. 14 showing a partial schematic diagram of a flat display panel 400 comprising a structure having repairing lines before a broken data line is repaired according to a third embodiment of the present invention. Elements in FIG. 14 having the same structure as those in FIG. 8 will be labeled by the same numerals. Differing from the “I”-shaped repairing lines 307a in FIG. 8, a profile of a repairing line 317a approximates to a half of the “I”-shaped repairing line 307a which is folded along a vertical line in a middle of the “I”-shaped repairing line 307a. The pixel electrode 300a near to the TFT 303a can be closer to the data line 302a than the pixel electrode 300a is in FIG. 8, thereby having greater aperture ratio.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A flat display panel, comprising:
a plurality of matrix-arranged pixel electrodes;
a plurality of scan lines in rows, parallel to one another and extended along a first direction, for transmitting scan signals;
a plurality of data lines in columns, parallel to one another and extended along a second direction which is perpendicular to the first direction, for transmitting data signals;
a plurality of thin-film transistors (TFTs), coupled to the plurality of pixel electrodes, the plurality of scan lines in rows, and the plurality of data lines in columns one on one, each of the plurality of TFTs conducting a coupled data line when each of the plurality of TFTs receives a scan signal transmitted through a coupled scan line, the data signal transmitted through the coupled data line to a corresponding pixel electrode; and
a plurality of repairing lines, parallel to and overlapped with the plurality of data lines in columns, the plurality of repairing lines disposed at one side of the plurality of pixel electrodes one on one and disconnected to one another, the plurality of repairing lines and the plurality of scan lines in rows made of the same metallic layer.

2. The flat display panel of claim 1, characterized in that: each of the plurality of repairing lines is in a shape of a letter “I”.

3. The flat display panel of claim 1, characterized in that: the flat display panel further comprises a plurality of connecting units, each of the plurality of connecting units having two ends, and the two ends overlapped with one end of two repairing lines in the same column, respectively, wherein when one of the data line is broken to form a gap, two of the plurality of repairing lines overlapped with the broken data line which is unable to transmit the data signal to the pixel electrode are chosen, the two repairing lines are placed at two sides of the gap of the broken data line and are overlapped with one of the plurality of connecting units, and the two repairing lines are electrically connected to the broken data line and the connecting unit.

4. The flat display panel of claim 3, characterized in that: the flat display panel further comprises an insulating layer placed between the plurality of repairing lines and the data line and a passivation layer placed between the plurality of connecting units and the data line.

5. The flat display panel of claim 3, characterized in that: the plurality of connecting units and the plurality of pixel electrodes are made of indium tin oxide (ITO).

6. The flat display panel of claim 1, characterized in that: when one of the plurality of data lines is broken to form a gap which is unable to transmit data signal, two ends of the gap of the broken data line are electrically connected to one of the plurality of repairing lines which is overlapped with the broken data line.

7. The flat display panel of claim 6, characterized in that: the flat display panel further comprises an insulating layer placed between the plurality of repairing lines and the data line.

8. A method of repairing a flat display panel, comprising:
providing a glass substrate;
forming a first metallic layer on the glass substrate;
etching the first metallic layer, for forming gates of a plurality of TFTs, a plurality of repairing lines, and a plurality of scan lines;
forming an insulating layer on the gates of the TFTs, on the repairing lines, and on the scan lines;
forming a semiconductor layer on the insulating layer;
etching the semiconductor layer, for forming channels of the TFTs; and
forming and etching a second metallic layer, for forming sources and drains of the TFTs and a plurality of data lines.

9. The method of repairing a flat display panel of claim 8, characterized in that: the method comprises steps of:
when one of the plurality of data lines is broken to form a gap which is over one of the repairing lines, selecting the repairing line overlapping the gap of the broken data line, and electrically connecting the broken data line with the selected repairing line;
forming a passivation layer on the data lines, the sources and the drains of the TFTs; and
forming a transparent conducting layer on the passivation layer.

10. The method of repairing a flat display panel of claim 8, characterized in that:
when one of the plurality of data lines is broken to form a gap which is not over any repairing lines, selecting two of the repairing lines which overlap two ends of the gap of the broken data line respectively, and electrically connecting the broken data line with the two selected repairing lines;
forming a passivation layer on the data lines, the sources and the drains of the TFTs;
forming a transparent conducting layer on the passivation layer;
etching the transparent conducting layer to form a connecting unit over the two selected repairing lines; and
electrically connecting the two repairing lines with the connecting unit.

11. The method of repairing a flat display panel of claim 10, characterized in that: the plurality of connecting units and the plurality of pixel electrodes are made of indium tin oxide (ITO).

12. The method of repairing a flat display panel of claim 10, characterized in that: the step of electrically connecting the broken data line with the two selected repairing lines is realized by irradiating overlapping areas of the two repairing lines and the broken data line with laser to weld the two repairing lines and the broken data line, and the step of electrically connecting the two repairing lines with the connecting unit is realized by irradiating the overlapping area of the two repairing lines and the connecting unit with laser to weld the two repairing lines and the connecting unit.

13. The method of repairing the flat display panel of claim 8, characterized in that: after the passivation layer is formed, the method further comprises:
etching the passivation layer, for forming a via on the drain; and
etching the transparent conducting layer to form a pixel electrode.
